(19) United States
(12) Patent Application Publication
(10) Pub. No.: US 2005/0084759 A1
(43) Pub. Date: Apr. 21, 2005

(54) Lithium-ion secondary battery

(76) Inventors: Mariko Miyachi, Tokyo (JP); Jiro Iriyama, Tokyo (JP); Ikiko Yamazaki, Tokyo (JP); Hironori Yamamoto, Tokyo (JP); Koji Utsugi, Tokyo (JP); Tamaki Miura, Tokyo (JP); Mitsuhiro Mori, Tokyo (JP); Yutaka Bannai, Tokyo (JP)

Correspondence Address: Norman P Soloway;Hayes Soloway, 130 W Cushing Street, Tucson, AZ, 85701, US

(21) Appl. No.: 10/500,165

(22) PCT Filed: Dec. 26, 2002
(86) PCT No.: PCT/JP02/13643

(30) Foreign Application Priority Data
Dec. 28, 2001 (JP) 2001-402063

(51) Int. Cl. H01M 4/40; H01M 4/58

(52) U.S. Cl. 429/231.95; 429/231.4; 29/623.1

(57) ABSTRACT

A lithium ion secondary battery provided with both high weight energy density and good cycle characteristics (capacity retaining ratio during an extended use). A secondary battery comprising a negative electrode having, as a negative electrode active material, carbon and a lithium absorbing material that forms an alloy with lithium, the above active material having a layer structure, a positive electrode capable of absorbing and desorbing lithium ions, and an electrolyte disposed between the positive and negative electrodes, wherein the Li content in the lithium absorbing material layer in the negative electrode is between 31 and 67% at a discharge depth of 100%.

### TECHNICAL FIELD

The present invention relates to a lithium ion secondary battery.

### BACKGROUND ART

Lithium ion secondary batteries have been under development in recent years, and, since their battery characteristics such as charge/discharge voltage, charge/discharge cycle life characteristic and shelf life characteristic are highly dependent on utilized electrode active materials, the electrode active materials have been improved to enhance the battery characteristics.

In the case where metal lithium is used as a negative electrode active material, it is possible to form a lightweight battery with high-energy density. In this case, however, dendrites are formed on the surface of the lithium metal at the time of charging as the charge/discharge cycle is repeated. The dendrites may penetrate a separator and cause a short circuit, thus shortening the life of the battery.

In order to solve the problem, there has been proposed a lithium secondary battery utilizing as a negative electrode lithium absorbing materials that are electrochemically alloyed with lithium at the time of charging, such as aluminum, silicon and tin (Solid State Ionics, 113-115, p57 (1998)).

The negative electrode using such lithium absorbing material has a high capacity, and absorbed/desorbed lithium ions per unit volume are large in quantity. However, the negative electrode is progressively pulverized or flakes off as the charge/discharge cycle is repeated due to the expansion and contraction of the lithium absorbing material being an electrode active material when absorbing and desorbing lithium ions, which results in the short charge/discharge cycle life.

Consequently, there has been proposed to use a graphite material that has a reversible ability to absorb and desorb lithium ions as a negative electrode. The graphite material does not have the aforementioned pulverization problem, and combines relatively excellent cycle performance and safety. However, since graphite absorbs Li in the form of LiC₆, it has a capacity of up to 372 mAh/g per unit of weight only and has a low weight energy density.

As a means of realizing high energy density by a combination of the lithium absorbing material and graphite material, it has been suggested that a carbon negative electrode could be coated with the lithium absorbing material. Since the capacity of the base graphite material does not much decrease, a certain amount of capacity can be maintained for the whole of the negative electrode even when there is a decrease in the capacity of a silicon layer. Consequently, cycle characteristics are more improved than would be the case with the lithium absorbing material alone. Nevertheless, there is still a decrease in the capacity of the silicon layer because of the expansion and contraction of silicon, and therefore, good cycle characteristics as when using a carbon material only cannot be obtained.

### PROBLEMS THAT THE INVENTION IS TO SOLVE

It is therefore an object of the present invention to provide a lithium ion secondary battery provided with both high weight energy density and good cycle characteristics

### DISCLOSURE OF THE INVENTION

In accordance with the present invention, there is provided a lithium ion secondary battery comprising a positive electrode capable of absorbing and desorbing lithium ions and a negative electrode including a first layer that is largely composed of carbon and a second layer that contains an element to be alloyed with lithium, wherein the lithium content of the second layer is between 31 and 67 atomic-% at a discharge depth of 100%. Incidentally, the discharge depth means the ratio of discharged capacity to dischargeable capacity. A discharge depth of 100% indicates a condition where a battery has been discharged completely without being stopped in the middle.

According to the present invention, the lithium content of the second layer is between 31 and 67 atomic-% at a discharge depth of 100%. Consequently, it is possible to effectively prevent the progress of pulverization of the second layer due to expansion and contraction caused by the absorption and desorption of lithium ions. Thus, cycle characteristics (charge/discharge cycle) can be remarkably improved.

According to another embodiment of the present invention, in the above-described lithium ion secondary battery, the capacity of the negative electrode is higher than that of the positive electrode.

Generally, a positive electrode active material is heavier than a negative electrode active material in weight. Therefore, in order to increase energy density per unit of weight, it is desirable to raise the rate of utilization of the positive electrode active material. With the aforementioned construction, the capacity of the negative electrode is higher than that of the positive electrode. Thus, it is possible to increase energy density per unit of weight.

Additionally, by setting the capacity of the negative electrode higher than that of the positive electrode, it becomes possible to sufficiently suppress the rise of anode or negative electrode potential caused by over discharge. As a result, over discharge characteristics can be improved.

According to another embodiment of the present invention, in the above-described lithium ion secondary battery, lithium in a quantity that satisfies the following formulas (1) and (2) is electrically connected to the positive electrode or the negative electrode:
Li=Cb(1=L_{c})+(Mₐₜₒₘ×Lₛ/(1−Lₛ))×Li_{capa} (1)
Li+Cat≦Cb+Mₐₜₒₘ×M_{capa} (2)
(wherein Li is the capacity or quantity of Li electrically connected to the positive electrode or the negative electrode, Cb is the capacity of active material contained in the first layer of the negative electrode, Lc is the initial charging/discharging efficiency of the first layer of the negative electrode, Mₐₜₒₘ is the number of atoms of active material contained in the second layer of the negative electrode, Lₛ is the Li content in the second layer of the negative electrode at a discharge depth of 100%, Li_{capa} is the capacity of a lithium atom, Cat is the capacity of the positive electrode, and M_{capa} is the capacity of an atom of lithium absorbing material contained in the second layer of the negative electrode).

In the above-described lithium ion secondary battery, the lithium absorbing material contained in the second layer of the negative electrode may include at least one element selected from Si, Ge, In, Sn, Ag, Al and Pb.

Particularly, in the above-described lithium ion secondary battery, the lithium absorbing material contained in the second layer of the negative electrode may include Si and/or Sn.

According to yet another embodiment of the present invention, in the above-described lithium ion secondary battery, the first layer of the negative electrode includes at least one selected from graphite, fullerene, carbon nanotube, DLC (Diamond Like Carbon), amorphous carbon, and hard carbon.

According to yet another embodiment of the present invention, in the above-described lithium ion secondary battery, the active material of the positive electrode includes at least one compound selected from lithium cobalt oxide, lithium manganese oxide, and lithium nickel oxide. Examples of the compound are not limited to lithium cobaltate, lithium manganate, and the like. In these compounds, elements, for example, titanium, silicon or the like may be substituted for part of elements, cobalt, manganese and nickel.

According to yet another embodiment of the present invention, in the above-described lithium ion secondary battery, the active material of the positive electrode includes lithium manganate. It is known that lithium manganate has excellent over discharge characteristics. In the case where the above-described negative electrode is combined with the positive electrode that contains lithium manganate, it is possible to improve over discharge characteristics as well as over charge characteristics. Thus, the reliability of the battery is vastly increased.

Further, in accordance with the present invention, there is provided a method for using a lithium ion secondary battery comprising a positive electrode capable of absorbing and desorbing lithium ions and a negative electrode including a first layer that is largely composed of carbon and a second layer that contains an element to be alloyed with lithium, wherein the lithium content in the second layer of the negative electrode is made between 31 and 67 atomic-% on completion of discharge.

According to the present invention, the lithium content in the second layer of the negative electrode is between 31 and 67 atomic-% at a discharge depth of 100%. Consequently, it is possible to effectively prevent the progress of pulverization of the second layer due to expansion and contraction caused by the absorption and desorption of lithium ions. Thus, cycle characteristics can be remarkably improved.

According to another embodiment of the present invention, in the above-described method for using the lithium ion secondary battery, the capacity of the negative electrode is higher than that of the positive electrode.

Generally, a positive electrode active material is heavier than a negative electrode active material in weight. Therefore, in order to increase energy density per unit of weight, it is desirable to raise the rate of utilization of the positive electrode active material. With the aforementioned construction, the capacity of the negative electrode is higher than that of the positive electrode. Thus, it is possible to increase energy density per unit of weight.

Still further, in accordance with the present invention, there is provided a method for manufacturing a lithium ion secondary battery comprising a positive electrode capable of absorbing and desorbing lithium ions and a negative electrode, involving the step of, after forming the negative electrode layers including a first layer that is largely composed of carbon and a second layer that contains an element to be alloyed with lithium, adding lithium in a quantity that satisfies the following formulas (A) to (D) to the second layer of the negative electrode:
Cb+Mₐₜₒₘ×M_{capa}>Cat (A)
0.31≦Lₛ≦0.67 (B)
Li=Cb(1−L_{c})+(Mₐₜₒₘ×Lₛ/(1−Lₛ))×Li_{capa} (C)
Li+Cat≦Cb+Mₐₜₒₘ×M_{capa} (D)
(wherein Li is the capacity of Li electrically connected to the positive electrode or the negative electrode, Cb is the capacity of active material contained in the first layer of the negative electrode, L_{c} is the initial charge/discharge efficiency of the first layer of the negative electrode, Mₐₜₒₘ is the number of atoms of lithium absorbing material being active material contained in the second layer of the negative electrode, Lₛ is the Li content in the second layer of the negative electrode at a discharge depth of 100%, Li_{capa} is the capacity of a lithium atom, Cat is the capacity of the positive electrode, and M_{capa} is the capacity of an atom of lithium absorbing material being active material contained in the second layer of the negative electrode).

### BRIEF DESCRIPTION OF THE DRAWINGS

FIG. 1 is a cross-sectional view showing an example of a negative electrode of a nonaqueous electrolyte secondary battery according to the first and second embodiments of the present invention.

FIG. 2 is a graph showing the relation between the Li content in a lithium absorbing material layer of the negative electrode at a discharge depth of 100% and the discharge capacity retention ratio after the 100th cycle.

FIG. 3 is a diagram for explaining the effect of an IR drop or dropping on the discharge capacity.

FIG. 4 is a cross-sectional view showing another example of a negative electrode of a nonaqueous electrolyte secondary battery according to the first and second embodiments of the present invention.

FIGS. 5(a) and 5(b) are diagrams for explaining the relation between the capacities of positive and negative electrodes and the capacity of additional Li.

FIG. 6 is a graph showing the charge/discharge curve of a nonaqueous electrolyte secondary battery according to the second embodiment of the present invention.

Incidentally, the reference numeral 1a represents a collector. The reference numeral 2a represents a carbon layer. The reference numeral 3a represents a lithium absorbing material layer.

### BEST MODE FOR CARRYING OUT THE INVENTION

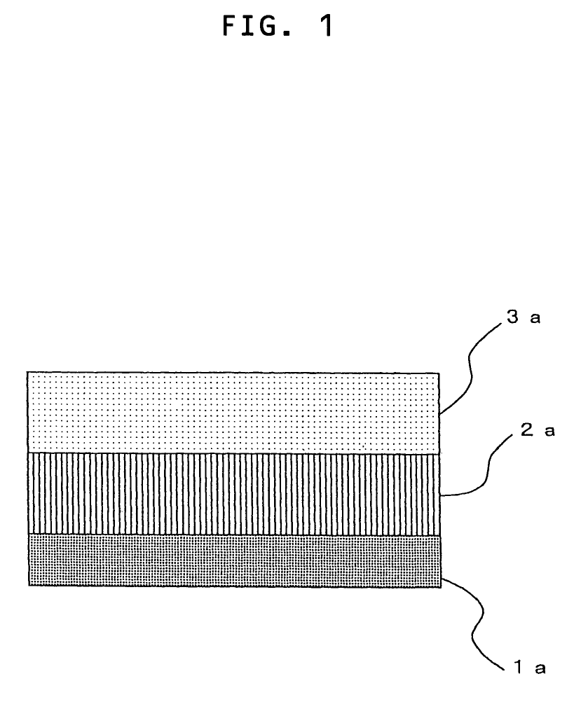

A lithium ion secondary battery according to the present invention comprises a negative electrode having, for example, a lithium absorbing material layer 3a mainly composed of an element that can be alloyed with Li on a carbon layer 2a formed on the collector 1a as shown in FIG. 1, and a positive electrode containing a lithium compound, Such as LiCoO₂, from which lithium ions can be electrochemically extracted.

In the case of the lithium secondary battery having the negative electrode according to the present invention, good cycle characteristics cannot be achieved if the battery is charged under the same condition as with a battery having a carbonaceous or graphite negative electrode. In other words, when setting a discharge voltage at 1 to 2.5 V as in the case of a carbonaceous or graphite negative electrode (counter electrode: metal lithium), most of lithium that can be extracted from the lithium absorbing material layer is drawn out. On this occasion, the volume of the lithium absorbing material layer is reduced due to the discharge of lithium absorbing material in the negative electrode. Consequently, the lithium absorbing material is pulverized. Besides, on the occasion of absorption and desorption of Li in such negative electrode, the degrees of expansion and contraction of volume differ between the carbon layer and the lithium absorbing material layer. Accordingly, stresses are produced, and the lithium absorbing material layer flakes off the carbon layer. The flaking and pulverization of the lithium absorbing material cause a serious deterioration in cycle characteristics.

Given this factor, in accordance with the present invention, the Li content in the lithium absorbing material layer on completion of discharge is controlled so as to be within a range of 31 to 67 atomic-%. Thereby, Li remains in the lithium absorbing material layer even after the completion of discharging, which alleviates expansion and contraction of the volume of the lithium absorbing material layer. As a result, the stresses produced between the carbon layer and the lithium absorbing material layer are reduced. Thus, it is possible to overcome the problem involved in the use of the aforementioned negative electrode. That is, the lithium absorbing material layer can be prevented from flaking off the carbon layer. For the above reason, good cycle characteristics can be achieved.

In the following, a description will be given of the reason why the Li content of the lithium absorbing material layer on completion of discharge is made between 31 and 67 atomic-%.

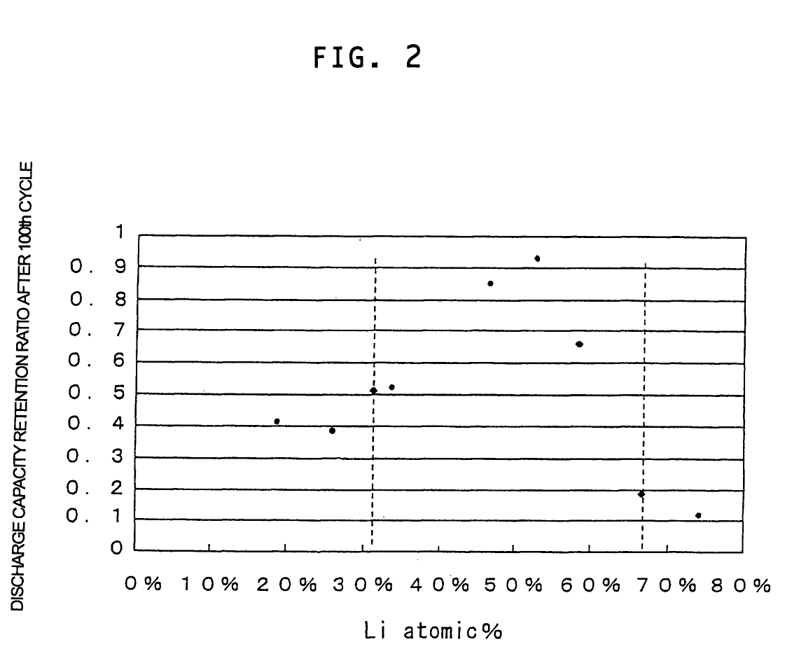

FIG. 2 is a graph showing the relation between the Li content in the lithium absorbing material layer of the negative electrode on completion of discharge (discharge depth: 100%) and the discharge capacity retention ratio after the 100th cycle. The examined lithium secondary battery has a negative electrode that includes a carbon layer, a silicon layer and lithium foil stacked on a collector in layers, and a positive electrode that contains lithium cobaltate as an active material. As can be seen in FIG. 2, when the Li content is low (less than 30 atomic-%) and also high (more than or equal to 70 atomic-%), the discharge capacity retention ratio is low. Looking at changes in the Li content from a low value to a high value in FIG. 2, it will be noted that the discharge capacity retention ratio is improved drastically after the point of 31 atomic-%. Meanwhile, looking at changes in the Li content from a high value to a low value, it will be noted that the discharge capacity retention ratio is improved drastically after the point of 67 atomic-%.

This phenomenon can be explained as follows. That is, in the case where the Li content in the lithium absorbing material layer of the negative electrode is less than 30 atomic-% on completion of discharge, expansion and contraction associated with charge/discharge cycles are not sufficiently alleviated. Consequently, the pulverization and flaking of the lithium absorbing material layer are not sufficiently suppressed. As a result, good cycle characteristics may not be achieved. On the other hand, in the case where the Li content exceeds 67 atomic-%, presumably, the discharge capacity retention ratio falls by the effect of the so-called IR drop. In the following, a description will be made of a decline in the discharge capacity retention ratio due to the IR drop.

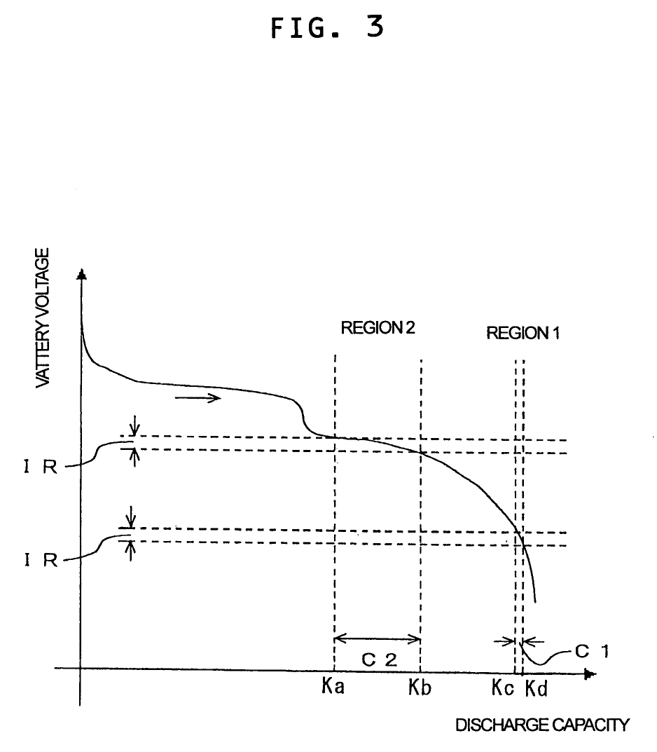

FIG. 3 shows an example of a discharge curve for a battery. Generally, a battery is designed so that its discharge stops at a prescribed voltage. Accordingly, the discharge capacity is determined. However, ill practice, the discharge sometimes stops at a voltage that has not been up to a discharge end voltage for various reasons. This is called IR drop. When the IR drop occurs, the actual discharge capacity of a battery, whose design discharge capacity is Kd, becomes Kc in FIG. 3, and the capacity corresponding to C1 is not to be discharged. Besides, the actual discharge capacity of a battery, whose design discharge capacity is Kb, becomes Ka, and the capacity corresponding to C2 is not to be discharged. As can be seen in FIG. 3, C2 is large as compared to C1 because the behavior of the discharge curve differs widely between areas 1 and 2. In other words, the difference in the design discharge capacity causes a large difference in the capacity not to be discharged due to the effect of the IR drop, namely, the difference between C1 and C2. Here, the discharge capacity is set low when the lithium absorbing material layer of the negative electrode has a high Li content, namely, the design discharge capacity corresponds to Kb. On the other hand, the discharge capacity is set high when the lithium absorbing material layer of the negative electrode has a low Li content, namely, the design discharge capacity corresponds to Kd. As is described above, it would appear that in the case where the Li content in the lithium absorbing material layer of the negative electrode exceeds 67 atomic-%, the discharge capacity retention ratio falls considerably.

For the reason stated above, by setting the Li content in the lithium absorbing material layer of the negative electrode on completion of discharge to be within a range of 31 to 67 atomic-%, it is possible to realize a lithium ion secondary battery provided with both high weight energy density and good cycle characteristics.

Incidentally, while silicon is used for the lithium absorbing material layer in the description of FIG. 2, silicon is given only as an example. The lithium absorbing material layer may be formed of active material other than silicon, such as Ge, In, Sn, Ag, Al, and Pb, with the same relation between the Li content in the lithium absorbing material layer of the negative electrode at a discharge depth of 100% and the discharge capacity retention ratio after the 100th cycle. These lithium absorbing materials each have a different discharge potential than that of carbon, and show the discharge curve as shown in FIG. 3. Consequently, there is made a difference in a capacity decrease due to the IR drop, and the discharge capacity retention ratio falls considerably in the high Li content value area in FIG. 3. Additionally, Si, Sn, Ge and Pb absorb about 4.4 lithium atoms per atom, and are similar to one another in lithium absorbing/desorbing behavior. Therefore, they share a common appropriate lithium content range in FIG. 2.

Besides, with respect to the relation between the Li content and the discharge capacity retention ratio shown in FIG. 2, by setting the Li content to be within a range of 31 to 67 atomic-% as in the case of the negative electrode using silicon, it is possible to achieve a good discharge capacity retention ratio even if using other active materials.

There is no particular limitation upon the order of stacking the carbon layer and the lithium absorbing material layer of the negative electrode used in the present invention. The lithium absorbing material layer may be formed first on the collector before forming the carbon layer. In this case, expansion and contraction of the volume of the lithium absorbing material layer are alleviated, and therefore, the stresses are reduced. Thus, the lithium absorbing material layer can be prevented from flaking off. Even when part of the lithium absorbing material layer flakes off the collector, unless the part also flakes off the carbon layer, the capacity does not decrease since conductivity is secured through the carbon layer. Further, the carbon layers and the lithium absorbing material layers may be stacked alternately in layers to form a multitiered structure negative electrode. Incidentally, when the surface of the negative electrode is provided with lithium foil, it is desirable that the layer directly underneath the foil should be the lithium absorbing material layer rather than the carbon layer.

[First Embodiment]

In the following, the first embodiment of the present invention will be described in detail with reference to the drawings. FIG. 1 is a cross-sectional view showing a negative electrode of a nonaqueous electrolyte secondary battery according to the first embodiment of the present invention.

The collector 1a is an electrode for letting electric current out of the battery and drawing current into the battery from the outside on the occasion of charging and discharging. The collector 1a is only required to be (conductive) metal (foil), and metallic foil. made of, for example, aluminum, copper, stainless steel, gold, tungsten, and molybdenum may be employed. The collector 1a is 5 to 25 μm in thickness.

The carbon layer 2a is a negative electrode member that absorbs or desorbs Li on the occasion of charging and discharging. The carbon layer 2a. is made of carbon capable of absorbing Li. For example, graphite, fullerene, carbon nanotube, DLC (Diamond Like Carbon), amorphous carbon, hard carbon may be used either individually or in mixtures with each other. The carbon layer 2a is 30 to 300 μm in thickness.

The lithium absorbing material layer 3a is a negative electrode member that absorbs or desorbs Li on the occasion of charging and discharging. The lithium absorbing material layer 3a is formed of metal, amorphous metal, alloy or metal oxide, or two or more kinds of metal, amorphous metal, alloy and/or metal oxide. The lithium absorbing material layer 3a may be a multitiered layer or a layer made of a mixture formed by, for example, CVD, deposition or sputtering. Moreover, the lithium absorbing material layer 3a may be formed by applying metal particles, alloy particles and metal oxide particles or a mixture of these with the use of a binder. Preferably, the lithium absorbing material layer 3a is made of metal, amorphous metal, or alloy, and includes at least one kind selected from the group of Si, Ge, In, Sn, Ag, Al and Pb. Although there is no particular limitation on the thickness of the lithium absorbing material layer 3a, it may be, for example, 0.1 to 240 μm in thickness. With this film thickness, it is possible to achieve both high capacity and, good productivity for batteries. In addition, the lithium absorbing material layer 3a may be doped with boron, phosphorous, arsenic, and antimony to further lower resistivity.

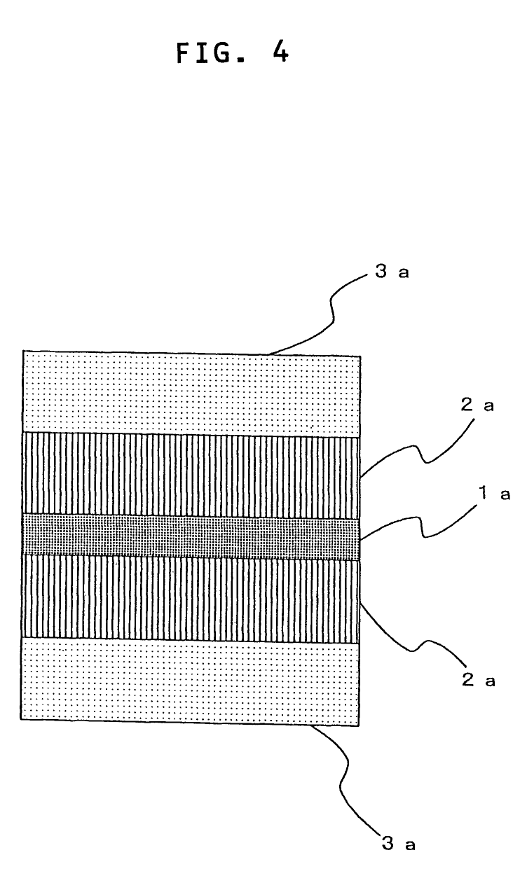

As a construction similar to that of FIG. 1, the carbon layer 2a and the lithium absorbing material layer 3a may be formed on both sides of the collector la as shown in FIG. 4.

A positive electrode available for the lithium secondary battery of the present invention may be formed in such a manner that composite oxides Li_{X}MO₂ (M indicates at least one transition metal), for example, Li_{X}CoO₂, Li_{X}NiO₂, Li_{X}Mn₂O₄, Li_{X}MnO₃, Li_{X}Ni_{y}CO_{1-y}O₂ or the like, a conductive substance such as carbon black and a binder such as polyvinylidene fluoride (PVDF) are dispersed and mixed in a solvent or a dispersion liquid such as N-methyl-2-pyrrolidone (NMP), and the mixture is applied over a base substance such as aluminum foil.

Besides, 5 V-level active materials may be used as the positive electrode active material. In other words, active materials having a plateau region at a metallic lithium counter electrode voltage of not less than 4.5 V may be employed. For example, lithium-containing combined oxides may be preferable. As examples of the available lithium-containing combined oxides may be cited spinel structure lithium-manganese combined oxide, olivine structure lithium-containing combined oxide, inverse spinel structure lithium-containing combined oxide or the like. Lithium-containing combined oxide may be a compound represented by the following general formula ( I ):
Liₐ(MₓMn_{2-x-y}A_{y}) O₄ (I)
(where 0<x, 0<y, x+y<2, and 0<a<1.2; M is at least one kind selected from the group consisting of Ni, Co, Fe, Cr and Cu; A is at least one kind selected from Si and Ti).

With the use of such compound, it is possible to realize a superior electromotive force stably. Here, if M includes at least Ni, cycle characteristics and the like are further improved. It is desirable that x should be set within a range so that the valence number of Mn becomes +3.9 or more. Further, when 0<y in the aforementioned compound, Mn is substituted with a lighter element. Thereby, the amount of discharge per unit of weight increases, and high capacity can be achieved.

The lithium secondary battery of the present invention can be manufactured in a manner as follows: after the negative electrode, which has a hydrophobic surface layer formed on the surface of lithium metal or a lithium alloy, and the above-mentioned positive electrode are stacked in layers via the separator, which is composed of a porous film made of fluorocarbon resin, polyolefin such as polypropylene and polyethylene or the like, in dried air or an inert gas atmosphere, or the stacked electrodes are wound, they are mounted in a battery can or sealed with a flexible film, which is composed of a layered product of synthetic resin and metallic foil, or the like.

An electrolytic solution is prepared by dissolving lithium salts in an aprotic organic solvent or the like. Examples of the organic solvent include: ring carbonates such as propylenecarbonate (PC), ethylenecarbonate (EC), butylenecarbonate (BC), and vinylenecarbonate (VC); chain carbonates such as dimethylcarbonate (DMC), diethylcarbonate (DEC), ethylmethylcarbonate (EMC), and dipropylcarbonate (DPC); aliphatic carboxylic acid esters such as methyl formate, methyl acetate, ethyl propionate: γ-lactones such as γ-butyrolactone; chain ethers such as 1,2-diethoxyethane (DEE) and ethoxymethoxyethane (EME); ring ethers such as tetrahydrofuran or its derivatives and 2-methyltetrahydrofuran; dimethylsulfoxide; 1,3-dioxolane; formamide; acetamide; dimethylformamide; dioxolane; acetonitrile; propylnitrile; nitromethane; ethylmonoglyme; triester phosphate; trimethoxymetane; dioxolane derivatives; sulfolane; methylsulfolane; 1,3-dimethyl-2-imidazolidinone; 3-methyl-2-oxazolidinone; propylenecarbonate derivatives; ethyl ether, 1,3-propanesultone; anisole; and N-methylpyrrolidone, which may be used either individually or in mixtures of two or more kinds. As examples of the lithium salts dissolved in the organic solvents may be cited LiPF₆, LiAsF₆, LiAlCl₄, LiClO₄, LiBF₄, LiSbF₆, LiCF₃SO₃, LiCF₃CO₂, Li (CF₃SO₂)₂, LiN (CF₃SO₂)₂, LiB₁₀Cl₁₀, lower aliphatic lithium carboxylate, lithium chloroborane, 4-lithium phenyl borate, LiBr, LiI, LiSCN, LiCl and imides. In addition, a polymer electrolyte may be used as a substitute for the electrolytic solution.

According to the first embodiment, in order to make the lithium content in the lithium absorbing material layer 3a between 31 and 67 atomic-% on completion of discharge, it may be proposed to set limits on the way of charging/discharging. More specifically, the Li content in the lithium absorbing material layer 3a is made between 31 and 67 atomic-% on completion of discharge by setting a limit on the discharge voltage based on such battery voltage or negative electrode potential (reference: Li metal) that the Li content in the lithium absorbing material layer 3a becomes 31 to 67 atomic-% on completion of discharge, or by setting a limit on the discharge time based on such discharge capacity that the Li content in the lithium absorbing material layer 3a becomes 31 to 67 atomic-%.

### EXAMPLE 1

In the following, the present invention will be more fully described by Example 1 according to the first embodiment of the present invention.

Copper foil, graphite having a thickness of 100 μm after compression and Si were used for the collector 1a, carbon layer 2a and lithium absorbing material layer 3a of the negative electrode shown in FIG. 1. respectively. A lithium cobaltate mixture was employed for a positive electrode or cathode active material, and aluminum foil was employed for a cathode collector. A mixed solvent of ethylenecarbonate (EC) and diethylcarbonate (DEC) (EC/DEC mixture ratio: 30 to 70 by volume), in which 1 mol/l (1M) of LiPF₆ was dissolved, was employed for an electrolyte solution. With the aforementioned negative electrode, positive electrode, electrolyte solution and a separator, a cylindrical secondary battery was formed. The electrodes were wound in a spiral.

The electric properties of the cylindrical secondary battery were examined by a charge/discharge tester. In order to provide Li content in the lithium absorbing material layer 3a, battery voltage limits shown in Table 1 were set in conducting tests.

As Comparative Example 1, tests were conducted on the same cylindrical secondary battery as that prepared in Example 1 with the battery voltage limits shown in Table 1.

As Comparative Example 2, a cylindrical secondary battery was prepared with a negative electrode formed by applying the mixture of Si particles, a binder and conductive adjuvant to a collector made of Cu foil, a separator, the aforementioned positive electrode and electrolyte solution, and tests were conducted on the battery with the battery voltage limits shown in Table 1.

In both Example 1 and Comparative Example 1, the batteries or cells were disassembled after the initial discharge and part of the electrodes were cut out. Then, secondary ion mass spectrometry was carried out to measure the Li content in the lithium absorbing material layer 3a. Results of the tests are shown in Table 1. The Li content of the lithium absorbing material layer 3a was 53 atomic-% on completion of discharge in Example 1 and Comparative Example 2, while that in Comparative Example 1 was 16 atomic-%.

Further, the batteries were continuously discharged and recharged until the 300th cycle in Example 1, and Comparative Examples 1 and 2 The capacity retention ratios after the 300th cycle are shown in Table 1. The capacity retention ratios were obtained using the following formula (II):
(discharge capacity in each cycle)/(discharge capacity in the 10th cycle) (II)

Compared with Comparative Example 1 in which the Li content of the lithium absorbing material layer 3a was 16 atomic-%, in Example 1 where the Li content of the lithium absorbing material layer 3a was 53 atomic-% on completion of discharge, the capacity retention ratio after the 300th cycle rose by 65%. On the other hand, compared with Comparative Example 2 in which Si particles were used for the negative electrode, in Example 1, the capacity retention ratio after the 300th cycle rose by 80%. As just described, Example 1 proved that cycle characteristics were enormously improved when the lithium absorbing material layer 3a contained Li on completion of discharge.

In addition, Table 1 shows the energy density (Wh/kg) per unit of weight after the 300th cycle in respective Example 1, and Comparative Examples 1 and 2. Referring to Table 1, the energy density per unit of weight was 172 Wh/kg in Example l, and it was confirmed that a high energy density was achieved in Example 1.

TABLE 1

| | | | | Capacity | Energy |
|---|---|---|---|---|---|
| | | | Li Content | Retention | Density |
| | Voltage Limit | | of Layer 3a | Ratio | After |
| | After | After | After | After | 300th |
| | Charge | Discharge | Discharge | 300th | Cycle |
| | Voltage | Voltage | (atomic %) | Cycle | (Wh/kg) |
| Example 1 | 4.2 V | 3.6 V | 53% | 95.2% | 172 |
| Comparative | 4.2 V | 1.7 V | 16% | 30.0% | 63 |
| Example 1 | | | | | |
| Comparative | 4.2 V | 3.6 V | 53% | 15.1% | 27 |
| Example 2 | | | | | |

### EXAMPLE 2

In the following, the present invention will be more fully described by Example 2 according to the first embodiment of the present invention.

Copper foil, graphite having a thickness of 100 μm after compression and Si were employed for the collector 1a, carbon layer 2a and lithium absorbing material layer 3a of the negative electrode shown in FIG. 1, respectively. A lithium cobaltate mixture was employed for a positive electrode or cathode active material, and aluminum foil was employed for a cathode collector. A mixed solvent of ethylenecarbonate (EC) and diethylcarbonate (DEC) (EC/DEC mixture ratio: 30 to 70 by volume), in which 1 mol/l (1M) of LiPF₆ was dissolved, was employed for an electrolyte solution.

With the aforementioned negative electrode, positive electrode, electrolyte solution and a separator, a cylindrical secondary battery was produced. The electrodes were wound in a spiral.

The electric properties of the cylindrical secondary battery were examined by a charge/discharge tester. In order to provide Li content in the lithium absorbing material layer 3a, discharge capacity limits shown in Table 2 were set in conducting tests.

As Examples 3 and 4, tests were conducted on the same secondary batteries as that prepared in Example 2 with the discharge capacity limits shown in Table 2. In addition, as Comparative Example 3, tests were conducted on the same secondary battery as that prepared in Example 2 with the discharge capacity limits shown in Table 2.

In all the Examples 2, 3 and 4 and Comparative Examples 3, 4 and 5, the batteries or cells were disassembled after the initial discharge and part of the electrodes were cut out. Then, secondary ion mass spectrometry was carried out to measure the Li content in the lithium absorbing material layer 3a. Results of the tests are shown in Table 2. The Li content of the lithium absorbing material layer 3a was between 49 to 63 atomic-% on completion of discharge in each of Examples 2, 3 and 4, while those in Comparative Examples 3 and 4 were as low as 16 atomic-% and 27 atomic-%, respectively. Besides, the Li content of the lithium absorbing material layer 3a was as high as 73 atomic-% in Comparative Example 5.

Further, the batteries were continuously discharged and recharged until the 300th cycle in Examples 2, 3 and 4, and Comparative Examples 3, 4 and 5. The capacity retention ratios after the 300th cycle are shown in Table 2. The capacity retention ratios were obtained using the formula (II).

While the capacity retention ratio after the 300th cycle was 30% in Comparative Example 3 where there was no discharge capacity limit, in Examples 2, 3 and 4 and Comparative Example 5 where the Li content of the lithium absorbing material layer 3a was over 49 atomic-% on completion of discharge, the capacity retention ratio after the 300th cycle exceeded 94% and rose by more than 64%. On the other hand, in Comparative Example 4 where the Li content of the lithium absorbing material layer 3a was 27 atomic-% on completion of discharge, the capacity retention ratio was 45%, which was more than 49% below those of Examples 2, 3 and 4. As just described, Examples 2, 3 and 4 proved that cycle characteristics were enormously improved when the lithium absorbing material layer 3a had a Li content according to the first embodiment on completion of discharge.

In addition, Table 1 shows the energy density (Wh/kg) per unit of weight after the 300th cycle in respective Examples 2, 3 and 4 and Comparative Examples 3, 4 and 5. Referring to Table 2, the energy density per unit of weight was between 159 and 177 Wh/kg in Examples 2, 3 and 4, and was 69 Wh/kg or more higher as compared to Comparative Examples 3 and 4. On the other hand, in Comparative Example 5 where the capacity retention ratio after the 300th cycle was 94%, the energy density was 130 Wh/kg, and sufficient energy density was not achieved. As Examples 2, 3 and 4 show, it was confirmed that a battery provided with both high weight energy density (Wh/kg) and good cycle characteristics could be obtained when the lithium absorbing material layer 3a had a Li content of 31 to 67 atomic-% on completion of discharge.

TABLE 2

| | | | | Capacity | Energy |
|---|---|---|---|---|---|
| | | | Li Content | Retention | Density |
| | Discharge Condition | | of Layer | Ratio | After |
| | Discharge | | 3a After | After | 300th |
| | Time | Discharge | Discharge | 300th | Cycle |
| | Limit | Capacity | (atomic %) | Cycle | (Wh/kg) |
| Example 2 | 3.1 h | 370 mAh | 49% | 95.3% | 177 |
| Example 3 | 3 h | 360 mAh | 53% | 95.5% | 172 |
| Example 4 | 2.8 h | 330 mAh | 63% | 96.2% | 159 |
| Comparative | No Limit | 420 mAh | 16% | 30.1% | 63 |
| Example 3 | | | | | |
| Comparative | 3.3 h | 400 mAh | 27% | 45.0% | 90 |
| Example 4 | | | | | |
| Comparative | 2.3 h | 280 mAh | 73% | 94.1% | 130 |
| Example 5 | | | | | |

[Second Embodiment]

According to the first embodiment, the discharge has to be terminated when the discharge voltage reaches a specific limit or when a specific period of discharge time has passed so that the Li content in the lithium absorbing material layer of the negative electrode is between 3 1 and 67 atomic-% on completion of discharge. In this view, the first embodiment is impractical. Meanwhile, in accordance with the second embodiment, it is realized that the Li content in the lithium absorbing material layer of the negative electrode is between 31 and 67 atomic-% even when the discharge is carried on without being stopped in the middle until it reaches a depth of 100%, that is, the battery is completely discharged. Herein, the discharge depth means the ratio of discharged capacity to dischargeable capacity.

According to the second embodiment, in order that the Li content in the lithium absorbing material layer 3a is between 31 and 67 atomic-% at a discharge depth of 100%, the electrodes are designed so as to satisfy the conditions as follows:
Condition (1)—the capacity of the negative electrode is designed to be higher than that of the positive electrode
Condition (2)—Li is added to the positive or negative electrode so that the Li content in the lithium absorbing material layer 3a is between 31 and 67 atomic-%
Condition (3)—the capacities of the positive and negative electrodes satisfy the following formula (III):
   positive electrode capacity≦negative electrode capacity−additional Li capacity (III)

The above conditions can be represented using parameters as follows:
Condition (1)−Cb+Matom×Mcapa>Cat (IV)
Condition (2)−Li=Cb(1−Lc)+Matom×Ls/(1−Ls)×Licapa (V)
Condition (3)−Li+Cat≦Cb+Matom×Mcapa (VI)
(in formulas (IV) to (VI), Cb is the capacity of active material contained in the carbon layer 2a, Matom is the number of atoms of lithium absorbing material M contained in the lithium absorbing material layer 3a, Mcapa is the capacity of an atom of lithium absorbing material M contained in the lithium absorbing material layer 3a, Licapa is the capacity of an atom of Li, Li is the capacity of additional Li, Cat is the capacity of the positive electrode, Lc is the initial charge/discharge efficiency of the carbon layer 2a, and Ls is Li content in the lithium absorbing material layer 3a at a discharge depth of 100% (0.31 atomic-%<Ls<0.67 atomic-%)).

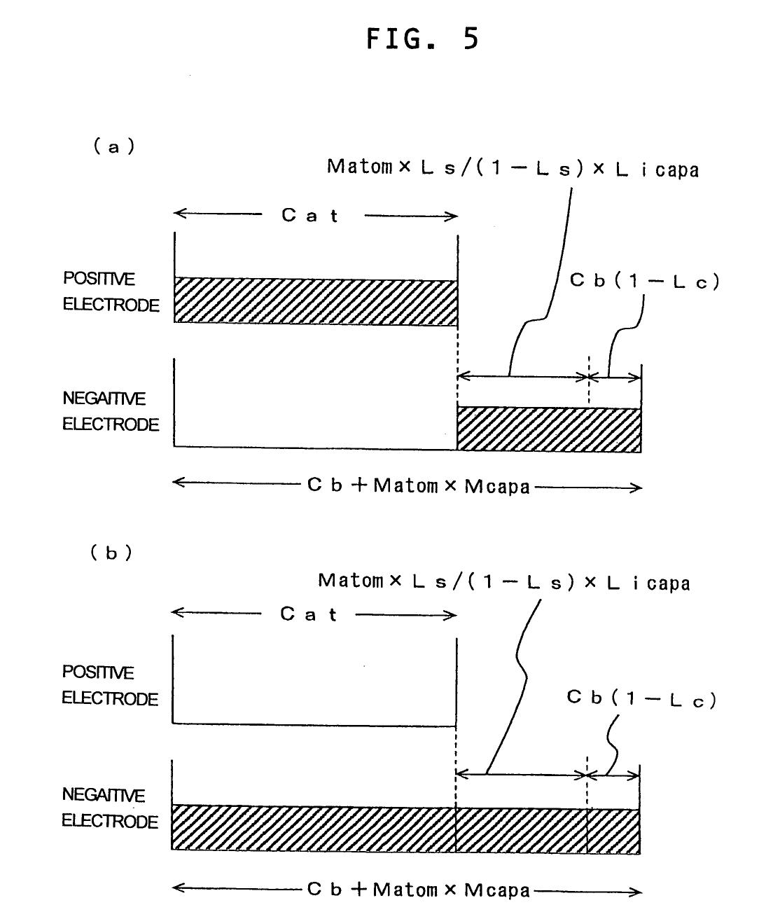

In the following, a description will be made of the reason why the Li content in the lithium absorbing material layer can be made between 31 and 67 atomic-% at a discharge depth of 100% according to the above-described battery design referring to FIG. 5. As an example of formula (VI), the case where Li+Cat=Cb+Matom×Mcapa will be explained.

FIG. 5(a) shows the initial state of a battery that satisfies the above conditions. First, the electrodes are designed so that the capacity of the negative electrode is higher than that of the positive electrode to meet condition (1). Then, in order to meet condition (3), Li in a quantity corresponding to the difference between the capacity of the negative electrode and that of the positive electrode, Cb (1−Lc)+Matom×Ls/(1−Ls)×Licapa, is added to the negative electrode. On this occasion, in order to meet condition (2), the capacity of added Li is made to coincide with the sum of the irreversible capacity of the carbon layer (Cb (1−Lc)) and the capacity of Li to be left in the lithium absorbing material layer at a discharge depth of 100% ((Matom×Ls/(1−Ls)×Licapa) corresponding to 31 to 67 atomic-% of the capacity of the lithium absorbing material layer of the negative electrode).

FIG. 5(b) shows the charged state of the above battery. When the battery is discharged to a discharge depth of 100%, Li in a quantity corresponding to the quantity or capacity of Li which moved from the positive electrode to the negative electrode at the time of charging moves from the negative electrode to the positive electrode. Thus, the battery is restored to the initial state shown in FIG. 5(a). Consequently, according to the above-described battery design, it is possible to leave a Li content of 31 to 67 atomic-% in the lithium absorbing material layer even if the battery is discharged to a discharge depth of 100% after the charged state shown in FIG. 5(b). Incidentally, Li of non-irreversible capacity that remains in the negative electrode is present in the lithium absorbing material layer. This is because the discharge potential of the carbon layer is lower than that of the lithium absorbing material layer, and Li that has absorbed in the carbon layer moves to the positive electrode first.

There are some conventional techniques for adding Li to the negative electrode (e.g. Japanese Patent Application laid open No. HEI 11-288705). However, the addition of Li in the conventional techniques is solely aimed at compensation for Li corresponding to the irreversible capacity of the carbon layer of the negative electrode. Therefore, at a discharge depth of 100%, the Li content that remains in the negative electrode may be normally 10%, and less than or comparable to 20% since the Li content higher than that is unfavorable for achieving high weight energy density, that is, the object of the present invention. On the other hand, according to the present invention, the addition of Li is made in order to control the Li content of the lithium absorbing material layer to be 31 to 67 atomic-% at a discharge depth of 100% as well as compensating for Li corresponding to the irreversible capacity differently from the conventional techniques.

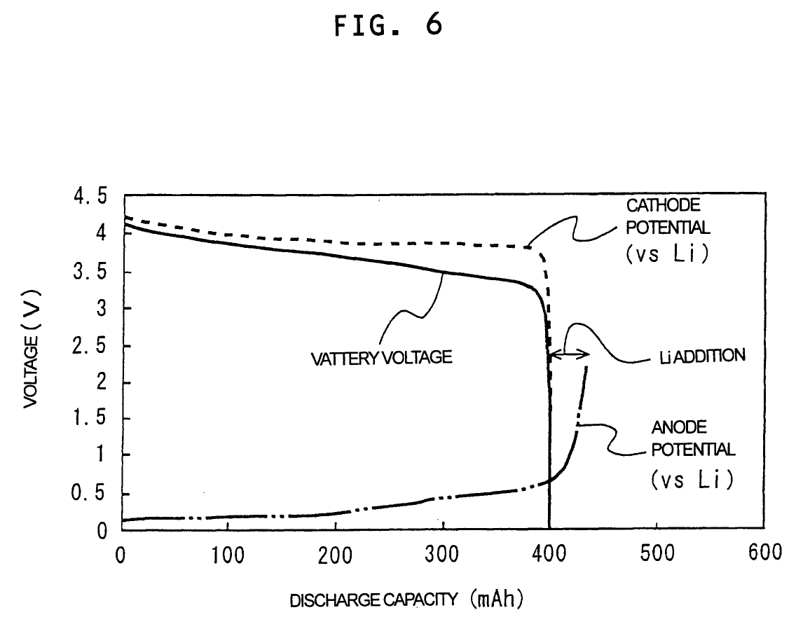

FIG. 6 is a graph showing an example of characteristics of the secondary battery whose electrodes has been designed so as to satisfy the above formulas (IV) to (VI). As can be seen in FIG. 6, the negative electrode has a Li content corresponding to the capacity of additional Li even after the discharge. Herewith, according to the battery design that satisfies the above conditions (1) to (3), it is possible to produce a battery in which the Li content in the lithium absorbing material layer 3a is between 31 and 67 atomic-% at a discharge depth of 100%.

Incidentally, in this embodiment, the same positive electrode, negative electrode, separator and electrolytic solution as previously described for the first embodiment may be utilized. Besides, in the case where lithium manganate is employed as a positive electrode or cathode active material, it is possible to produce a battery provided with excellent over charge characteristics as well as over discharge characteristics by the synergistic effect of the positive electrode and the negative electrode formed according to the battery design that satisfies the above formulas (IV) to (VI).

### EXAMPLE 5, 6 and 7

In the following, the present invention will be more fully described by Examples 5, 6 and 7 according to the second embodiment of the present invention.

In Example 5, a battery was formed based on the design of the electrode capacities that satisfied the above formulas (IV) to (VI).

Copper foil, graphite having a thickness of 100 μm after compression and Si were used for the collector 1a, carbon layer 2a and lithium absorbing material layer 3a of the negative electrode shown in FIG. 1, respectively. After forming the lithium absorbing material layer 3a, Li in a quantity shown in Table 3 was deposited thereon to make the addition of Li. A lithium cobaltate mixture was employed for a positive electrode or cathode active material, and aluminum foil was employed for a cathode collector. A mixed solvent of ethylenecarbonate (EC) and diethylcarbonate (DEC) (EC/DEC mixture ratio: 30 to 70 by volume), in which 1 mol/l (1M) of LiPF₆ was dissolved, was employed for an electrolyte solution.

In Example 6, after forming the positive electrode, it was plated with Li to make the addition of Li differently from Example 5. Otherwise, a cylindrical secondary battery was formed based on the same electrode design as shown in Table 3 and in the same manner as in Example 5.

In Example 7, after forming the lithium absorbing material layer 3a, Li foil was attached thereon to make the addition of Li differently from Example 5. Otherwise, a cylindrical secondary battery was formed based on the same electrode design as shown in Table 3 and in the same manner as in Example 5.

In comparative Example 6, the electrodes were designed as shown in Table 3, and a cylindrical secondary battery was formed with the same materials and in the same manner as in Example 5 based on the electrode design shown in Table 3.

The electric properties of the above-described cylindrical secondary batteries were examined by a charge/discharge tester. In all the Examples 5, 6 and 7 and Comparative Example 6, charging/discharging was carried out from 2.5 to 4.2 V.

In Examples 5, 6 and 7 and Comparative Example 6, the batteries or cells were disassembled after the initial discharge and part of the electrodes were cut out. Then, secondary ion mass spectrometry was carried out to measure the Li content-in the lithium absorbing material layer 3a. Results of the tests are shown in Table 4. The Li content of the lithium absorbing material layer 3a was 60 atomic-% at a discharge depth of 100% in Examples 5, 6 and 7, while that in Comparative Example 6 was 16 atomic-%.

In addition, part of the same electrodes as used in Examples 5, 6 and 7 and Comparative Example 6 were cut out into a circular form with a diameter of 1 cm. After that, coin- shaped batteries were produced with the use of Li metal as counter electrodes. Then, the positive electrodes were allowed to charge/discharge from 2.5 to 4.3 V, and the negative electrodes were allowed to charge/discharge from 2.5 to 0 V at 0.1 mA. In the initial charge/discharge, a capacity of 5 mAh was observed at 4.3 V with respect to each positive electrode of Examples 5, 6 and 7 and Comparative Example 6. On the other hand, with respect to the negative electrodes, a capacity of 6.25 mAh was observed at 0 V in Examples 5, 6 and 7, while a capacity of 5 mAh was observed in Comparative Example 6.

Further, the batteries were continuously discharged and recharged until the 300th cycle in Examples 5, 6 and 7 and Comparative Example 6. The capacity retention ratios after the 300th cycle are shown in Table 4. The capacity retention ratios were obtained using formula ( H ).

Compared with Comparative Example 6 in which the Li content of the lithium absorbing material layer 3a was 16 atomic-% at a discharge depth of 100%, in Examples 5, 6 and 7 where the Li content of the lithium absorbing material layer 3a was 60 atomic-% at a discharge depth of 100%, the capacity retention ratio after the 300th cycle rose by more than 64%. As just described, Examples 5, 6 and 7 proved that cycle characteristics were enormously improved by controlling the Li content in the lithium absorbing material layer 3a to be 31 to 67 atomic-% at a discharge depth of 100%.

Besides, Table 4 shows the weight energy density (Wh/kg) after the 300th cycle in respective Examples 5, 6 and 7 and Comparative Example 6. Referring to Table 4, the weight energy density was 169 Wh/kg in Example 5, 168 Wh/kg in Example 6, and 169 Wh/kg in Example 7. That is, the weight energy density was improved by 113 Wh/kg or more in Examples 5, 6 and 7 as compared to Comparative Example 6. Thus, it was confirmed that a high energy density was achieved in Examples 5, 6 and 7.

TABLE 3

| | Positive Electrode | Negative Electrode | Additional Li |
|---|---|---|---|
| | Capacity | Capacity | Capacity |
| Example 5 | 500 mAh | 625 mAh | 125 mAh |
| Example 6 | 500 mAh | 625 mAh | 125 mAh |
| Example 7 | 500 mAh | 625 mAh | 125 mAh |
| Comparative | 500 mAh | 500 mAh | 0 mAh |
| Example 6 | | | |

TABLE 4

| | Li Content of | Capacity | Weight Energy |
|---|---|---|---|
| | Layer 3a After | Retention Ratio | Density After |
| | Discharge | After 300th | 300th Cycle |
| | (atomic %) | Cycle | (Wh/kg) |
| Example 5 | 60% | 95.0% | 169 |
| Example 6 | 60% | 94.5% | 168 |
| Example 7 | 60% | 94.8% | 169 |
| Comparative | 16% | 30.1% | 55 |
| Example 6 | | | |

### EXAMPLES 8, 9 and 10

In the following, the present invention will be more fully described by Examples 8, 9 and 10 according to the second embodiment of the present invention.

In Example 8, a battery was formed based on the design of the electrode capacities as show in FIG. 5, which satisfied the above formulas (IV) to (VI).

TABLE 5

| | Positive Electrode | Negative Electrode | Additional Li |
|---|---|---|---|
| | Capacity | Capacity | Capacity |
| Example 8 | 500 mAh | 601 mAh | 101 mAh |
| Example 9 | 500 mAh | 601 mAh | 101 mAh |
| Example 10 | 500 mAh | 601 mAh | 101 mAh |
| Comparative | 500 mAh | 500 mAh | 0 mAh |
| Example 7 | | | |

The electrodes were prepared based on the design of the electrode capacities shown in Table 5, and a battery was formed. Copper foil, graphite having a thickness of 100 μm after compression and Si were used for the collector 1a, carbon layer 2a and lithium absorbing material layer 3a of the negative electrode shown in FIG. 1, respectively. After forming the lithium absorbing material layer 3a, Li in a quantity shown in Table 5 was deposited thereon to make the addition of Li. A lithium cobaltate mixture was employed for a positive electrode or cathode active material, and aluminum foil was employed for a cathode collector. A mixed solvent of ethylenecarbonate (EC) and diethylcarbonate (DEC) (EC/DEC mixture ratio: 30 to 70 by volume), in which 1 mol/l (1M) of LiPF₆ was dissolved, was employed for an electrolyte solution.

In Example 9, Sn was employed as a constituent element of the lithium absorbing material layer 3a instead of Si used in Example 8. Otherwise, a cylindrical secondary battery was formed based on the same electrode design as shown in Table 5 and in the same manner as in Example 8.

In Example 10, Ge was employed as a constituent element of the lithium absorbing material layer 3a instead of Si used in Example 8. Otherwise, a cylindrical secondary battery was formed based on the same electrode design as shown in Table 5 and in the same manner as in Example 8.

In comparative Example 7, the electrodes were designed as shown in Table 5, and a cylindrical secondary battery was formed with the same materials and in the same manner as in Example 8 based on the electrode design shown in Table 5.

The electric properties of the above-described cylindrical secondary batteries were examined by a charge/discharge tester. In all the Examples 8, 9 and 10 and Comparative Example 7, charging/discharging was carried out from 2.5 to 4.2 V.

In Examples 8, 9 and 10 and Comparative Example 7, the batteries or cells were disassembled after the initial discharge and part of the electrodes were cut out. Then, secondary ion mass spectrometry was carried out to measure the Li content in the lithium absorbing material layer 3a. Results of the tests are shown in Table 6. The Li content of tile lithium absorbing material layer 3a was 57 atomic-% at a discharge depth of 100% in Examples 8, 9 and 10, while that in Comparative Example 7 was 17 atomic-%.

In addition, part of the same electrodes as used in Examples 8, 9 and 10 and Comparative Example 7 were cut out into a circular form with a diameter of 1 cm. After that, coin-shaped batteries were produced with the use of Li metal as counter electrodes. Then, the positive electrodes were allowed to charge/discharge from 2.5 to 4.3 V, and the negative electrodes were allowed to charge/discharge from 2.5 to 0 V at 0.1 mA. In Examples 8, 9 and 10 and Comparative Example 7, a capacity of 5 mAh was observed with respect to the positive electrodes. On the other hand, with respect to the negative electrodes, a capacity of 6.01 mAh was observed in Examples 8, 9 and 10, while a capacity of 5 mAh was observed in Comparative Example 7.

Further, the batteries were continuously discharged and recharged until the 300th cycle in Examples 8, 9 and 10 and Comparative Example 7. The capacity retention ratios after the 300th cycle are shown in Table 6. The capacity retention ratios were obtained using formula (II).

Compared with Comparative Example 7 in which the Li content of the lithium absorbing material layer 3a was 17 atomic-% at a discharge depth of I 00%, in Examples 8, 9 and 10 where the Li content of the lithium absorbing material layer 3a was 57 atomic-% at a discharge depth of 100%, the capacity retention ratio after the 300th cycle rose by more than 64%. As just described, Examples 8, 9 and 10 proved that cycle characteristics were enormously improved when the lithium absorbing material layer 3a contained Li at a discharge depth of 100%.

Besides, Table 6 shows the weight energy density (Wh/kg) after the 300th cycle in respective Examples 8, 9 and 10 and Comparative Example 7. Referring to Table 6, the weight energy density was 168 Wh/kg in Example 8, 169 Wh/kg in Example 9, and 170 Wh/kg in Example 10. That is, the weight energy density was improved by 1 13 Wh/kg or more in Examples 8, 9 and 10 as compared to Comparative Example 7. Thus, it was confirmed that a high energy density was achieved in Examples 8, 9 and 10.

TABLE 6

| | Li Content of | | Weight Energy |
|---|---|---|---|
| | Layer 3a After | Capacity | Density After |
| | Discharge | Retention Ratio | 300th Cycle |
| | (atomic %) | After 300th Cycle | (Wh/kg) |
| Example 5 | 57% | 94.3% | 168 |
| Example 6 | 57% | 94.7% | 169 |
| Example 7 | 57% | 95.2% | 170 |
| Comparative | 17% | 30.2% | 55 |
| Example 6 | | | |

### EXAMPLE 11

In the following, the present invention will be more fully described by Example 11 according to the second embodiment of the present invention. In Example 11, the capacities of the electrodes were designed as shown in Table 7 so as to meet conditions (1), (2) and (3) of the second embodiment.

TABLE 7

| | Positive Electrode | Negative Electrode | Additional Li |
|---|---|---|---|
| | Capacity | Capacity | Capacity |
| Example 11 | 500 mAh | 625 mAh | 125 mAh |
| Example 12 | 500 mAh | 625 mAh | 125 mAh |
| Comparative | 500 mAh | 500 mAh | 0 mAh |
| Example 8 | | | |

The electrodes were prepared based on the design of the electrode capacities shown in Table 7, and a battery was formed. Copper foil, graphite having a thickness of 100 μin after compression and Si were used for the collector 1a, carbon layer 2a and lithium absorbing material layer 3a of the negative electrode shown in FIG. 1, respectively. After forming the lithium absorbing material layer 3a, Li in a quantity shown in Table 7 was deposited thereon to make the addition of Li. A lithium cobaltate mixture was employed for a positive electrode or cathode active material, and aluminum foil was employed for a cathode collector. A mixed solvent of ethylenecarbonate (EC) and diethylcarbonate (DEC) (EC/DEC mixture ratio: 30 to 70 by volume), in which 1 mol/l (1M) of LiPF₆ was dissolved, was employed for an electrolyte solution.

### EXAMPLE 12

In Example 12, a lithium manganate mixture was employed for a positive electrode active material instead of what was used in Example 11. Otherwise, a cylindrical secondary battery was formed based on the same electrode design as shown in Table 7 and in the same manner as in Example 11.

### COMPARATIVE EXAMPLE 8

In comparative Example 8, the electrodes were designed as shown in Table 7, and a cylindrical secondary battery was formed with the same materials and in the same manner as in Example 11 based on the electrode design shown in Table 8.

In all the Examples 11 and 12 and Comparative Example 8, the batteries were discharged and recharged repeatedly through several numbers of cycles under a constant current of 0.6 A on the condition that the charge final voltage be 4.2 V and the discharge final voltage be 2.5 V. After the discharge of the 10th cycle (the discharge capacity in the 10th cycle will be denoted by \mathring{1}), the batteries were taken out, and allowed to discharge to 0 V with a resistance load of 1KΩ. Then, the batteries were left as they were for two weeks. After that, the batteries were charged up to the charge final voltage 4.2 V under a constant current of 0.6 A, and subsequently, discharged to the discharge final voltage 2.5 V under a constant current of 0.6 A. The discharge capacity in this case will be denoted by \mathring{2}. Further, in Example 12 and Comparative Example 8, the batteries were discharged and recharged repeatedly under a constant current of 0.6 A on the condition that the charge final voltage be 4.2 V and the discharge final voltage be 2.5 V. On the occasion of the charge of the 11th cycle, the charge final voltage was set to 5.0 V. Then, the batteries were left as they were for two weeks. After that, the batteries were discharged to 2.5 V, and subsequently, charged up to the charge final voltage 4.2 V under a constant current of 0.6 A. Thereafter, the battery was discharged to the discharge final voltage 2.5 V under a constant current of 0.6 A. The discharge capacity in this case will be denoted by \mathring{3}.

In Examples 11 and 12 and Comparative Example 8, the batteries or cells were disassembled after the initial discharge and part of the electrodes were cut out. Then, secondary ion mass spectrometry was carried out to measure the Li content in the lithium absorbing material layer 3a. Results of the tests are shown in Table 8. The Li content of the lithium absorbing material layer 3a was 60 atomic-% in Examples 11 and 12, while that in Comparative Example 8 was 16 atomic-%.

Table 8 shows the capacity retention ratio (%) to the discharge capacity in the 10th cycle after a discharge of 0 V in respective Examples 11 and 12, and Comparative Example 8. Compared with Comparative Example 8 in which the Li content of the lithium absorbing material layer 3a was 16 atomic-% on completion of discharge, in Examples 11 and 12 where the Li content of the lithium absorbing material layer 3a was 60 atomic-% on completion of discharge, the capacity retention ratio after a discharge of 0 V rose by more than 26%. Incidentally, the above capacity retention ratios (%) were calculated using the following formula (*VI):
\mathring{2}/\mathring{1}×100=capacity retention ratio (%) (*VII)

In Examples 11 and 12, improvement in over discharge characteristics was achieved because the negative electrode capacity>the positive electrode capacity, and therefore a rise in the potential of the negative electrode caused by the over discharge could be sufficiently suppressed. As just described, Examples 11 and 12 proved that over discharge characteristics were enormously improved.

Besides, Table 8 shows the capacity retention ratio (%) to the discharge capacity in the 10th cycle after a charge of 5 V in Example 12 and Comparative Example 8. Compared with Comparative Example 8 in which the Li content of the lithium absorbing material layer 3a was 16 atomic-% on completion of discharge, in Example 12, the capacity retention ratio after a charge of 5 V was 90.9%, and rose by more than 15%. Thus, it was confirmed that excellent over discharge characteristics were achieved in Example 12 where lithium manganate was employed for the positive electrode. Incidentally, the above capacity retention ratios (%) were found out using the following formula (*VIII):
\mathring{3}/\mathring{1}×100=capacity retention ratio(%) (*VIII)

TABLE 8

| | | Capacity | Capacity |
|---|---|---|---|
| | | Retention Ratio to | Retention Ratio to |
| | | Discharge | Discharge |
| | Li Content of | Capacity in 10th | Capacity in 10th |
| | Layer 3a After | Cycle After 0 V | Cycle After 5 V |
| | Discharge | Discharge (%) | Charge (%) |
| | (atomic %) | (*VII) | (*VIII) |
| Example 11 | 60% | 94.8% | — |
| Example 12 | 60% | 94.2% | 90.7% |
| Comparative | 16% | 62.0% | 60.1% |
| Example 8 | | | |

### EXAMPLE 13

In the following, the present invention will be more fully described by Example 13 according to the second embodiment of the present invention. In Example 13, the capacities of the electrodes were designed as shown in Table 9 so as to satisfy the above formulas (IV) to (VI) for producing a battery.

TABLE 9

| | Positive Electrode | Negative Electrode | Additional Li |
|---|---|---|---|
| | Capacity | Capacity | Capacity |
| Example 13 | 500 mAh | 580 mAh | 80 mAh |
| Comparative | 500 mAh | 500 mAh | 0 mAh |
| Example 9 | | | |

The electrodes were prepared based on the design of the electrode capacities shown in Table 9, and a battery was formed. Copper foil, hard carbon having a thickness of 100 μm after compression and Si were used for the collector 1a, carbon layer 2a and lithium absorbing material layer 3a of the negative electrode shown in FIG. 1, respectively. After forming the lithium absorbing material layer 3a, Li in a quantity shown in Table 9 was deposited thereon to make the addition of Li. A spinal structure lithium-manganese combined oxide (LiNi_{0.5}Mn_{1.5}O₄) mixture having a plateau region at a metallic lithium counter electrode voltage of not less than 4.5 V was employed for a positive electrode or cathode active material, and aluminum foil was employed for a cathode collector. A mixed solvent of ethylenecarbonate (EC) and diethylcarbonate (DEC) (EC/DEC mixture ratio: 30 to 70 by volume), in which 1 mol/l (1M) of LiPF₆ was dissolved, was employed for an electrolyte solution.

In comparative Example 9, the electrodes were designed as shown in Table 9, and a cylindrical secondary battery was formed based oil the electrode design shown in Table 9.

The electric properties of the above-described cylindrical secondary batteries were examined by a charge/discharge tester. In Example 13 and Comparative Example 9, the batteries were allowed to charge/discharge from 2.5 to 4.75 V.

In both Example 13 and Comparative Example 9, the batteries or cells were disassembled after the initial discharge and part of the electrodes were cut out. Then, secondary ion mass spectrometry was carried out to measure the Li content in the lithium absorbing material layer 3a. Results of the tests are shown in Table 10. The Li content of the lithium absorbing material layer 3a was 53 atomic-% at a discharge depth of 100% in Example 13, while that in Comparative Example 9 was 16 atomic-%.

Besides, part of the same electrodes as used in Example 13 and Comparative Example 9 were cut out into a circular form with a diameter of 1 cm. After that, coin-shaped batteries were produced with the use of Li metal as counter electrodes. Then, the positive electrodes were allowed to charge/discharge from 2.5 to 4.85 V, and the negative electrodes were allowed to charge/discharge from 2.5 to 0 V at 0.1 mA. In Example 13 and Comparative Example 9, a capacity of 5 mAh was observed at 4.85 V with respect to the positive electrodes. On the other hand, with respect to the negative electrodes, a capacity of 5.8 mAh was observed at 0 V in Example 13, while a capacity of 5 mAh was observed in Comparative Example 9.

Further, the batteries were continuously discharged and recharged until the 300th cycle in Example 13 and Comparative Example 9. The capacity retention ratios after the 300th cycle are shown in Table 10. The capacity retention ratios were obtained using formula ( II).

Compared with Comparative Example 9 in which the Li content of the lithium absorbing material layer 3a was 16 atomic-% at a discharge depth of 100%, in Example 13 where the Li content of the lithium absorbing material layer 3a was 53 atomic-% at a discharge depth of 100%, the capacity retention ratio after the 300th cycle rose by more than 60%. As just described, Example 13 proved that cycle characteristics were enormously improved when the lithium absorbing material layer 3a contained Li at a discharge depth of 100%.

Besides, Table 10 shows the weight energy density (Wh/kg) after the 300th cycle in Example 13 and Comparative Example 9. Referring to Table 10, the weight energy density was 182 Wh/kg in Example 13, and it was improved by 121 Wh/kg or more as compared to Comparative Example 9. Thus, it was confirmed that a high energy density was achieved in Example 13.

TABLE 10

| | Li Content of | | Weight Energy |
|---|---|---|---|
| | Layer 3a After | Capacity | Density After |
| | Discharge | Retention Ratio | 300th Cycle |
| | (atomic %) | After 300th Cycle | (Wh/kg) |
| Example 13 | 53% | 90.3% | 182 |
| Comparative | 16% | 30.1% | 61 |
| Example 9 | | | |

### EXAMPLE 14

In the following, the present invention will be more fully described by Example 14 according to the second embodiment of the present invention. In Example 14, the capacities of the electrodes were designed as shown in Table 11 so as to satisfy the above formulas (IV) to (VI) for producing a battery.

TABLE 11

| | Positive Electrode | Negative Electrode | Additional Li |
|---|---|---|---|
| | Capacity | Capacity | Capacity |
| Example 14 | 500 mAh | 563 mAh | 63 mAh |
| Example 15 | 455 mAh | 563 mAh | 63 mAh |
| Example 16 | 417 mAh | 563 mAh | 63 mAh |
| Example 17 | 385 mAh | 563 mAh | 63 mAh |
| Comparative | 500 mAh | 500 mAh | 0 mAh |
| Example 10 | | | |

The electrodes were prepared based on the design of tile electrode capacities shown in Table I l, and a battery was formed. Copper foil graphite having a thickness of 100 μm in after compression and Si were use(d for the collector 1a, carbon layer 2a and lithium absorbing material layer 3a of the negative electrode shown in FIG. 1, respectively. After forming the lithium absorbing material layer 3a, Li in a quantity shown in Table 11 was deposited thereon to make the addition of Li. A lithium manganate mixture was employed for a positive electrode or cathode active material, and aluminum foil was employed for a cathode collector. A mixed solvent of ethylenecarbonate (EC) and diethylcarbonate (DEC) (EC/DEC mixture ratio: 30 to 70 by volume), in which 1 mol/l (1M) of LiPF₆ was dissolved, was employed for an electrolyte solution.

As Examples 15, 16 and 17, the electrodes were produced based on the electrode design shown in Table 11 differently from the electrode structure of Example 14. Otherwise, cylindrical secondary batteries were formed in the same manner as in Example 14.

As comparative Example 10, the electrodes were designed as shown in Table 11, and a cylindrical secondary battery was formed with the same materials and in the same manner as in Example 14 based on the electrode design shown in Table 11.

The electric properties of the above-described cylindrical secondary batteries were examined by a charge/discharge tester. In Examples 14 to 17 and Comparative Example 10, charging/discharging was carried out from 2.5 to 4.2 V.

In all the Examples 14 to 17 and Comparative Example 10, the batteries or cells were disassembled after the initial discharge and part of the electrodes were cut out. Then, secondary ion mass spectrometry was carried out to measure the Li content in the lithium absorbing material layer 3a. Results of the tests are shown in Table 12. The Li content of the lithium absorbing material layer 3a was 49 atomic-% at a discharge depth of 100% in Examples 14 to 17, while that in Comparative Example 10 was 16 atomic-%.

Besides, part of the same electrodes as used in Examples 14 to 17 and Comparative Example 10 were cut out into a circular form with a diameter of 1 cm. After that, coin-shaped batteries were produced with the use of Li metal as counter electrodes. Then, the positive electrodes were allowed to charge/discharge from 2.5 to 4.3 V, and the negative electrodes were allowed to charge/discharge from 2.5 to 0 V at 0.1 mA. In the initial charge/discharge, a capacity of 5 mAh was observed in Example 14 and Comparative Example 10, a capacity of 4.55 mAh was observed in Example 15, a capacity of 4.17 mAh was observed in Example 16 and a capacity of 3.85 mAh was observed in Example 17 at 4.3 V with respect to the positive electrodes. On the other hand, with respect to the negative electrodes, a capacity of 5.63 mAh was observed at 0 V in Examples 14 to 17, while a capacity of 5 mAh was observed in Comparative Example 10.

Further, the batteries were continuously discharged and recharged until the 300th cycle in Examples 14 to 17 and Comparative Example 10. The capacity retention ratios after the 300th cycle are shown in Table 12. The capacity retention ratios were obtained using formula ( II).

Compared with Comparative Example 10 in which the Li content of the lithium absorbing material layer 3a was 16 atomic-% at a discharge depth of 100%, in Examples 14 to 17 where the Li content of the lithium absorbing material layer 3a was 49 atomic-% at a discharge depth of 100%, the capacity retention ratio after the 300th cycle rose by more than 63%. As just described, Examples 14 to 17 proved that cycle characteristics were enormously improved when the lithium absorbing material layer 3a contained Li at a discharge depth of 100%.

Besides, Table 10 shows the weight energy density (Wh/kg) after the 300th cycle in Examples 14 to 17 and Comparative Example 10. Referring to Table 12, the weight energy density was over 147 Wh/kg in Examples 14 to 1 7, and it was improved by 93 Wh/kg or more as compared to Comparative Example 10. Thus, it was confirmed that a high energy density was achieved in Examples 14 to 17.

TABLE 12

| | Li Content of | | Weight Energy |
|---|---|---|---|
| | Layer 3a After | Capacity | Density After |
| | Discharge | Retention Ratio | 300th Cycle |
| | (atomic %) | After 300th Cycle | (Wh/kg) |
| Example 14 | 49% | 94.6% | 168 |
| Example 15 | 49% | 95.1% | 161 |
| Example 16 | 49% | 93.9% | 152 |
| Example 17 | 49% | 94.3% | 147 |
| Comparative | 16% | 30.1% | 54 |
| Example 10 | | | |

Industrial Applicability

In accordance with the present invention, the negative electrode has higher capacity than that of the positive electrode, and the Li content in a layer that is largely composed of lithium ion absorbing material is controlled to be 31 to 67 atomic-% at a discharge depth of 100% in order to alleviate the expansion and contraction of the volume of the lithium absorbing material layer on the occasion of charging and discharging. Thus, the lithium absorbing material layer can be prevented from being pulverized and flaking off. As a result, it is possible to obtain a lithium ion secondary battery provided with both high weight energy density and good cycle characteristics.

1. A lithium ion secondary battery comprising a positive electrode capable of absorbing and desorbing lithium ions and a negative electrode including a first layer that is largely composed of carbon and a second layer that contains an element to be alloyed with lithium, wherein the lithium content of the second layer is between 31 and 67 atomic-% at a discharge depth of 100%.

2. The lithium ion secondary battery claimed in claim 1, wherein the capacity of the negative electrode is higher than that of the positive electrode.

3. The lithium ion secondary battery claimed in claim 2, wherein lithium in a quantity that satisfies the following formulas (1) and (2) is electrically connected to the positive electrode or the negative electrode:
Li=Cb(1−L_{c})+(Mₐₜₒₘ×Lₛ/(1−Lₛ))×Li_{capa} (1);
Li+Cat≦Cb+Mₐₜₒₘ×M_{capa} (2);
(wherein Li represents the capacity of Li electrically connected to the positive electrode or the negative electrode, Cb represents the capacity of active material contained in the first layer, L_{c} represents the initial charging/discharging efficiency of the first layer, Mₐₜₒₘ represents the number of atoms of lithium absorbing material contained in the second layer, Lₛ represents the Li content in the second layer at a discharge depth of 100%, Li_{capa} represents the capacity of a lithium atom, Cat represents the capacity of the positive electrode, and M_{capa} represents the capacity of an atom of lithium absorbing material contained in the second layer).

4. The lithium ion secondary battery claimed in claim 1, wherein the element to be alloyed with lithium is at least one selected from Si, Ge, In, Sn, Ag, Al and Pb.

5. The lithium ion secondary battery claimed in claim 1, wherein, as the element to be alloyed with lithium, Si and/or Sn is/are included.

6. The lithium ion secondary battery claimed in claim 1, wherein the first layer includes at least one selected from graphite, fullerene, carbon nanotube, diamond like carbon, amorphous carbon, and hard carbon.

7. The lithium ion secondary battery claimed in claim 1, wherein the active material of the positive electrode includes at least one compound selected from lithium cobalt oxide, lithium manganese oxide, and lithium nickel oxide.

8. The lithium ion secondary battery claimed in claim 1, wherein the active material of the positive electrode includes lithium manganate.

9. A method for using a lithium secondary battery comprising a positive electrode capable of absorbing and desorbing lithium ions and a negative electrode including a first layer that is largely composed of carbon and a second layer that contains an element to be alloyed with lithium, wherein the lithium content in the second layer of the negative electrode is made between 31 and 67 atomic-% on completion of discharge.

10. The method for using a lithium ion secondary battery claimed in claim 9, wherein the capacity of the negative electrode is higher than that of the positive electrode.

11. The method for using a lithium ion secondary battery claimed in claim 9, wherein the element to be alloyed with lithium is at least one selected from Si, Ge, In, Sn, Ag, Al and Pb.

12. The method for using a lithium ion secondary battery claimed in claim 9, wherein, as the element to be alloyed with lithium, Si and/or Sn is/are included.

13. A method for manufacturing a lithium ion secondary battery comprising a positive electrode capable of absorbing and desorbing lithium ions and a negative electrode, involving the step of, after forming the negative electrode including a first layer that is largely composed of carbon and a second layer that contains an element to be alloyed with lithium, adding lithium in a quantity that satisfies the following formulas (A) to (D) to the surface of the positive electrode or the negative electrode:
Cb+Mₐₜₒₘ×M_{capa}>Cat (A);
0.31≦Lₛ≦0.67 (B);
Li=Cb(1−L_{c})+(Mₐₜₒₘ×Lₛ/(1−Lₛ))×Li_{capa} (C);
Li+Cat≦Cb+Mₐₜₒₘ×M_{capa} (D);
(wherein Li represents the capacity of Li electrically connected to the positive electrode or the negative electrode, Cb represents the capacity of active material contained in the first layer of the negative electrode, L_{c} represents the initial charge/discharge efficiency of the first layer of the negative electrode, Mₐₜₒₘ represents the number of atoms of lithium absorbing material being active material contained in the second layer of the negative electrode, Lₛ represents the Li content in the second layer of the negative electrode at a discharge depth of 100%, Li_{capa} represents the capacity of a lithium atom, Cat represents the capacity of the positive electrode, and M_{capa} represents the capacity of an atom of lithium absorbing material being active material contained in the second layer of the negative electrode).
